(19) United States
(12) Patent Application Publication
(10) Pub. No.: US 2025/0091959 A1
(43) Pub. Date: Mar. 20, 2025

(54) METHOD FOR MANUFACTURING A THICK PART MADE OF CMC COMPOSITE MATERIAL

(71) Applicant: SAFRAN CERAMICS, LE HAILLAN (FR)

(72) Inventors: Emilie Chantal Gisèle MENDEZ, MOISSY-CRAMAYEL (FR); Alexandre MARCHAIS, MOISSY-CRAMAYEL (FR); Nicolas EBERLING-FUX, MOISSY-CRAMAYEL (FR); Mélissa BAZERQUE, MOISSY-CRAMAYEL (FR)

(21) Appl. No.: 18/291,792

(22) PCT Filed: Jul. 15, 2022
(86) PCT No.: PCT/FR2022/051418

§ 371 Date: Jan. 24, 2024

(30) Foreign Application Priority Data
Jul. 26, 2021 (FR) FR2108108

(51) Int. Cl. C04B 35/573; C04B 35/626; C04B 35/628; C04B 35/634; C04B 35/80

(52) U.S. Cl. CPC C04B 35/573; C04B 35/62675; C04B 35/62868; C04B 35/62873; C04B 35/63404; C04B 35/80; C04B 2235/3418; C04B 2235/428; C04B 2235/48; C04B 2235/5244; C04B 2235/5252; C04B 2235/616; C04B 2235/6562; C04B 2235/6567

(57) ABSTRACT

A method for manufacturing a part made of ceramic matrix composite (CMC) material includes producing a fibrous preform from silicon carbide fibres; consolidating the fibrous preform by gas-phase chemical infiltration; injecting a slurry including a silicon carbide particle powder into the consolidated fibrous preform; and densifying by infiltrating the preform with a composition based on molten silicon to give a part made of CMC material. The slurry further includes at least one organic binder. The method includes, prior to the infiltrating of the preform with a composition based on molten silicon, pyrolysing the organic binder so as to form a carbon-containing residue in the fibrous preform.

### TECHNICAL FIELD

The invention relates to a method for manufacturing a part made of ceramic matrix composite material (CMC) wherein the matrix is formed by infiltration of a silicon-based composition in the molten state (“Melt-Infiltration” (MI)).

### PRIOR ART

A field of application of the invention is the production of parts that are intended to be exposed to high temperatures in service, especially in the aeronautical and spatial fields, in particular parts of hot portions of aeronautical turbomachines; it being noted that the invention can be applied in other fields, for example in the field of industrial gas turbines.

CMC composite materials have good thermostructural properties, in other words high mechanical properties which make them suitable for forming structural parts, and the ability to retain these properties at high-temperatures.

The use of CMC materials in place of metal materials for parts exposed to high temperatures in service is therefore recommended, especially since CMC materials have a substantially lower density than the metal materials that they substitute.

A well known method for the manufacture of parts made of CMC material comprises the following steps:
producing a fibrous texture from fibres of carbon or silicon carbide (SiC),
consolidating a fibrous preform produced by chemical vapour infiltration (CVI) of SiC, the fibrous texture being held in the conformation tool during the CVI,
injecting a slurry of SiC powder into the fibrous preform (“slurry cast” or “slurry transfer moulding”),
infiltrating the preform with a composition based on molten silicon so as to form a ceramic matrix; a known densification process referred to as “melt infiltration” (MI).

Such a method is described, in particular, in document US2019337859.

This method can be used to obtain good material health for parts having a low thickness, typically less than 3 mm. By contrast, when the manufactured parts have a larger thickness, typically greater than 5 mm, defects corresponding to porosity appear in the core of the part.

However, there is a need for thick parts with an internal porosity that is as low as possible.

### DISCLOSURE OF THE INVENTION

To this end, the invention proposes a method for manufacturing a part made of ceramic matrix composite material, said method comprising:
producing a fibrous preform from fibres made of silicon carbide (SiC);
consolidating the fibrous preform by gas-phase chemical infiltration;
injecting a slurry comprising an SiC particle powder into the consolidated fibrous preform, the silicon carbide particles comprising silicon oxycarbide and silica on their surface,
densifying by infiltrating the preform with a composition based on molten silicon to give a part made of ceramic matrix composite material,
   characterised in that the slurry further comprises at least one organic binder and in that the method comprises, before the infiltration of the preform with a composition based on molten silicon, a step of forming an amorphous carbon residue by pyrolysing the organic binder and a step of carbon reduction of the silicon oxycarbide and silica present on the surface of the silicon carbide particles by the carbon residue.

The inventors have determined, after study, that the appearance of pores in the core of the part is connected to the inability of silicon or its alloy to wet SiC particles which are poorly deoxidised, these particles having a thin layer of silica (SiO₂) or SiOC on the surface. The contact angle of silicon on silica is greater than 90°.

Carbon formed by pyrolysis of the organic binder present in the slurry enables the carbon reduction of the SiC particles. More specifically, the carbon present reacts preferentially with the silica or SiOC in order to form carbon monoxide (CO) and SiC, which enables the SiC powder to be deoxidised. The wettability of the SiC particles by silicon is thus considerably improved, which enables the appearance of pores at the core to be avoided. Thus thick parts having good material health are obtained.

In addition, the use of an organic binder in the slurry enables the SiC particles to aggregate and enables these particles to concentrate in the fibrous preform in a different manner to that obtained with a slurry without binder. More specifically, the levels of compaction obtained are lower with the slurries using a binder. This makes it possible to more easily evacuate the gas from deoxidation and, consequently, to prolong the deoxidation reaction (no thermodynamic equilibrium between products and reactants in this situation).

According to a particular aspect of the method of the invention, the slurry comprises between 1% and 20% by weight organic binder.

According to another particular aspect of the method of the invention, the organic binder is chosen from water soluble binders and/or organic plasticisers and can be, for example, the following binders: polyvinyl alcohol (PVA), polyethylene glycol (PEG), glycerol, polymethylmethacrylate (PMMA), acrylic resin and polyvinyl butyral resin (PVB).

According to another particular aspect of the method of the invention, the fibrous preform comprises between 0.001% and 0.25% by weight amorphous carbon after the pyrolysis step of the organic binder.

According to another particular aspect of the method of the invention, the pyrolysis step comprises an increase in temperature at a rate between 1° C./min and 3° C./min to a temperature plateau between 300° C. and 500° C., the temperature plateau being maintained for a duration of between 1 and 5 hours.

According to another particular aspect of the method of the invention, this further comprises, before the first densification step, depositing on the fibres of the fibrous preform, an interphase of pyrolytic carbon, boron nitride or silicon-doped boron nitride.

The method for manufacturing a part made of SiC/SiC composite material of the invention can be applied, in particular, to the manufacture of a blade, nozzle, turbine ring or combustion chamber of a gas turbine.

### BRIEF DESCRIPTION OF THE FIGURES

FIG. 1 is a flow diagram indicating the successive steps of an embodiment of a method according to the invention,

FIG. 2 is a microscopy photograph of a thick part made of composite material obtained by implementing a method outside of invention,

FIG. 3 is a microscopy photograph of a thick part made of composite material obtained by implementing an exemplary method according to the invention.

### DESCRIPTION OF THE EMBODIMENTS

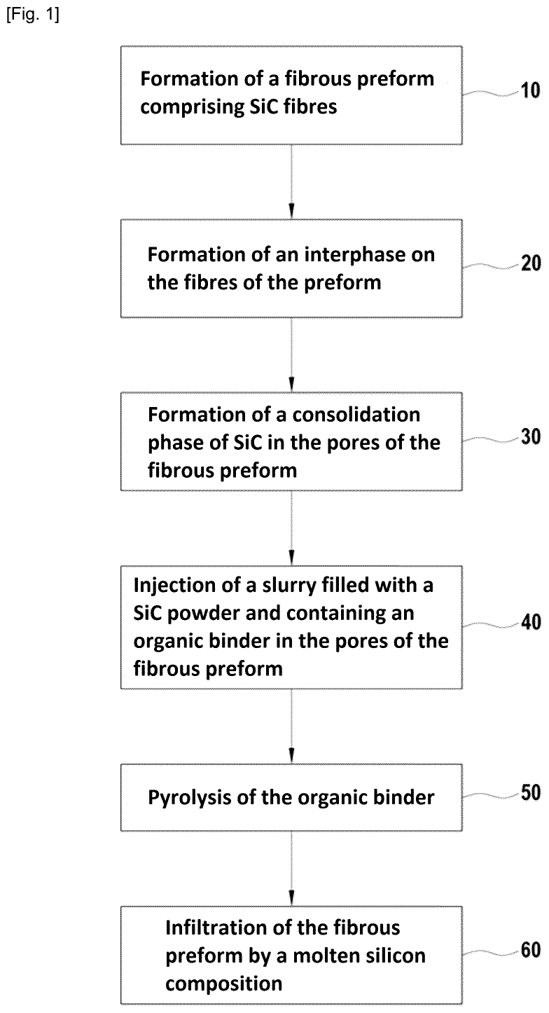

The various steps of an exemplary method according to the invention are represented in FIG. 1.

First, a fibrous preform comprising silicon carbide fibres is formed (step 10). This fibrous preform is intended to form the fibrous reinforcement of the part to be obtained. The fibres used can be silicon carbide (SiC) fibres supplied under the names “Nicalon”, “Hi-Nicalon” or “Hi-Nicalon-S” by Japanese company Nippon Carbon or “Tyranno SA3” supplied by the company UBE.

The fibrous preform can be obtained by three-dimensional weaving between a plurality of layers of warp yarns and a plurality of layers of weft yarns. The three-dimensional weaving can be performed using an “interlock” weave, i.e. a weave in which each layer of weft yarns interlinks a plurality of layers of warp yarns, with all of the yarns in the same weft column having the same movement in the weave plane.

Different weaving methods which can be used are described in the document WO 2006/136755.

The fibrous preform can also be obtained by assembling a plurality of fibrous textures. In this case, the fibrous textures can be linked together, for example by sewing or needling. In particular, the fibrous textures can each be obtained from a layer, or a stack of several layers, of:
one-dimensional tissue (UD),
two-dimensional tissue (2D),
braiding,
knitting,
felt,
one-dimensional sheet (UD) of yarns or tows, or multidirectional sheets (nD) obtained by superposition of a plurality of UD sheets in different directions and linking together of the UD sheets, for example by sewing, by chemical bonding agent or by needling.

In the case of a stack of several layers, these are linked together, for example, by sewing, implantation of rigid yarns or elements or by needling.

Once the preform is formed, an embrittlement-release interphase can be formed on the fibres of the preform (step 20).

In known manner, a surface treatment of the fibres prior to the formation of the interphase is preferably carried out in order to remove the sizing and a surface layer of oxide such as silica SiO₂ present on the fibres. The interphase can be formed by CVI. The interphase can be monolayer or multilayer. The interphase can comprise one or more layers of pyrolytic carbon (PyC), boron nitride (BN), or boron-doped carbon, denoted BC (boron doped carbon has an atomic content of boron between 5% and 20%, the remainder being carbon). The thickness of the interphase can be greater than or equal to 10 nm and, for example, be between 10 nm and 1000 nm. Of course, it does not go beyond the scope of the invention when the interphase is formed on the fibres before formation of the preform.

A consolidation phase comprising silicon carbide is then formed in the pores of the fibrous preform in a manner known per se (step 30). The consolidation phase can be formed by chemical vapour infiltration. The consolidation phase can comprise only silicon carbide. Alternatively, the consolidation phase can comprise, in addition to silicon carbide, a self-healing material. It is possible to choose a self-healing material containing boron, for example ternary system Si—B—C or boron carbide B₄C capable of forming, in the presence of oxygen, a borosilicate glass having self healing properties. The thickness of the deposit of the consolidation phase can be greater than or equal to 500 nm, for example between 1 μm and 30 μm. The outer layer of the consolidation phase (furthest away from the fibres) is advantageously made of silicon carbide, in order to constitute a reaction barrier between the underlying fibres and the molten silicon composition subsequently introduced.

The thickness of the consolidation phase is sufficient to consolidate the fibrous preform, in other words to bind together the fibres of the preform in a sufficient manner so that the preform can be manipulated while maintaining its shape without the assistance of maintenance tools. After this consolidation, the preform remains porous, the initial porosity only being filled, for example, for a minority portion by the interphase and the consolidation phase.

The following step consists of injecting a slurry comprising a powder of silicon carbide particles into the fibrous preform (“slurry cast” or “slurry transfer moulding”) (step 40).

In accordance with the invention, the slurry further comprises at least one organic binder. The organic binder used here is suitable for producing carbon residues by pyrolysis. The main function of the organic binder is not to form a coating of carbon on the surface of the SiC particles, but to enable the carbon reduction of the SiC particles and, consequently, the deoxidation of these particles as explained below. More precisely, the organic binder is a binder having a degree of carbonisation less than 5%. The organic binder is the able to form between 1% and 5% by weight amorphous carbon (coke content) after pyrolysis. The organic binder can be chosen from water soluble binders and/or organic plasticisers and can be, for example, the following binders: polyvinyl alcohol (PVA), polyethylene glycol (PEG), glycerol, polymethylmethacrylate (PMMA), acrylic resin and polyvinyl butyral resin (PVB). By choosing an organic binder having a degree of carbonisation less than 5%, capable of forming between 1% and 5% by weight amorphous carbon (coke content) after pyrolysis, an amorphous carbon residue is formed in the preform which enables the carbon reduction of the SiC particles and, consequently, their deoxidation.

The slurry comprises between 1% and 20% by weight organic binder, relative to the weight of SiC present in the slurry and more preferably between 1% and 10% by weight.

The slurry comprises a content of SiC powder filler between 30% and 50% by volume and, more preferably, a content of 45% by volume.

The viscosity of the slurry is less than 500 mPa·s (cPs) and is therefore very fluid and easy to inject.

The use of an organic binder in the slurry already contributes a first effect before heat treatment. More specifically, the binder makes it possible to maintain a flocculation state of the SiC particles and will play the role of steric hindrance, which will concentrate (stack) the particles in the fibrous preform in a manner different from that obtained with a slurry without binder. The levels of compaction obtained are then lower with a slurry filled using a binder. This makes it possible to have larger channels of pores and to more easily evacuate the gas from deoxidation and, consequently, to prolong the deoxidation reaction (no thermodynamic equilibrium between products and reactants in this situation).

By way of example, the level of compaction of a fibrous preform impregnated with a slurry filled with SiC particles and without organic binder is between 55% and 65%, whereas the level of compaction of a fibrous preform impregnated with a slurry filled with SiC particles and comprising an organic binder is between 45% and 50%. The average size of the channels of pores present in the fibrous preform after injection/filtration of a slurry of SiC particles and without organic binder is less than 100 nm, whereas the average size of the pore channels present in the fibrous preform after injection/filtration of a slurry of SiC particles and comprising an organic binder is between 100 nm and 300 nm.

Still in accordance with the invention, a heat treatment of pyrolysis of the organic binder is then carried out in order to form a carbon residue in the preform (step 50). The pyrolysis step is carried out at a temperature between 300° C. and 500° C. More precisely, as a function of the quantity of organic binder present in the slurry, the pyrolysis step comprises an increase in temperature at a rate between 1° C./min and 3° C./min to a temperature plateau between 300° C. and 500° C., the temperature plateau being maintained for a duration between 1 hour and 5 hours. This pyrolysis step (temperature increase and plateau) can be carried out before the final densification step by infiltration of the preform with a composition based on molten silicon, in other words a separate heat treatment, or during the temperature increase ramp in preparation for the infiltration of the preform with a composition based on molten silicon, the melting temperature of which is much greater than that of the pyrolysis of the organic binder. In any case, the pyrolysis step is carried out before the infiltration of the preform with a composition based on molten silicon.

At this stage of the method, a preform is obtained which comprises between 0.001% and 0.25% by weight amorphous carbon. This carbon residue promotes the carbon reduction of the SiC particles. More specifically, the carbon present reacts preferentially with the silica or silicon oxycarbide (SiOC) present at the surface of the SiC particles, in order to form carbon monoxide (CO) and SiC, which enables deoxidising of the SiC powder. The wettability of the SiC particles by silicon is thus considerably improved.

The infiltration of the fibrous preform by the molten composition comprising mostly molten silicon by weight is then performed (step 60). This composition can correspond to molten silicon alone or to a silicon alloy in the molten state, which also contains one or more other elements such as titanium, molybdenum, boron, iron or niobium. The mass content of silicon in the molten composition can be greater than or equal to 90%.

Through the deoxidation of the SiC particles by the carbon residue from the pyrolysis of the organic binder, the molten silicon or alloy thereof easily wets the silicon carbide present in the preform, which greatly facilitates its penetration into the pores of the preform by capillary action.

Thus, a part made of ceramic matrix composite material is obtained which has a very low level of porosity, even in the case of thick parts typically greater than 5 mm.

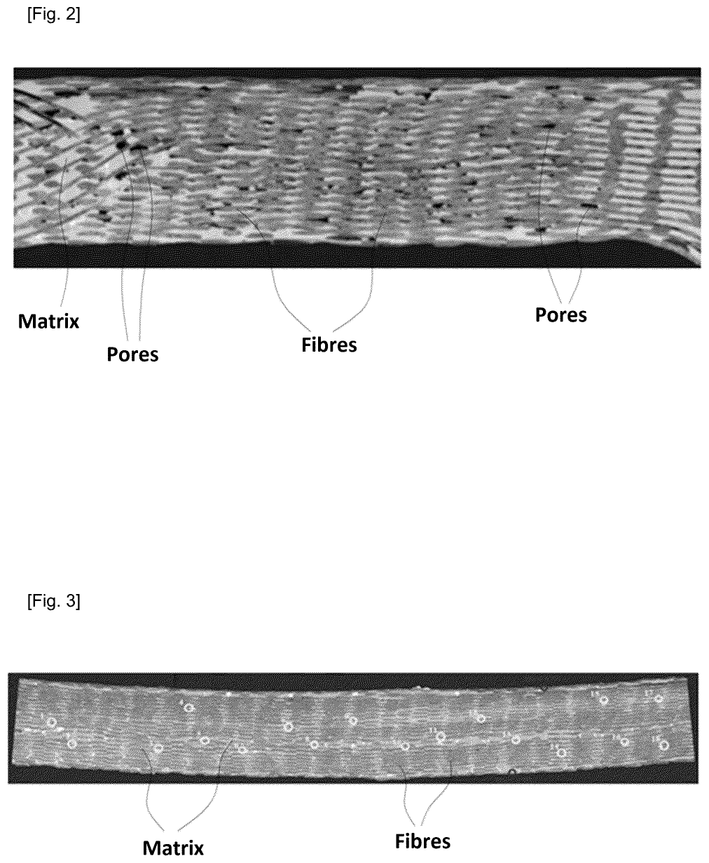

FIGS. 2 and 3 are microscopy photographs showing the morphology of a thick area of parts made of CMC composite material obtained by implementing the following steps:
producing a fibrous texture from SiC fibres,
consolidating a fibrous preform by SiC CVI,
injecting a slurry of SiC powder into the fibrous preform (“slurry cast” or “slurry transfer moulding”),
infiltrating the preform with a composition based on molten silicon.

For the part shown in FIG. 2, the slurry does not contain organic binder, while the slurry used for manufacturing the part of FIG. 3 contains an organic binder according to the invention, as described above. It is observed that the part shown in FIG. 2 has a significant residual porosity, whereas the part of FIG. 3 is ideally densified, the space between the fibres being entirely filled by the matrix.

1. A method for manufacturing a ceramic matrix composite part comprising:
producing a fibrous preform from silicon carbide fibres;
consolidating the fibrous preform by gas-phase chemical infiltration;
injecting a slurry comprising a silicon carbide particle powder into the consolidated fibrous preform, the silicon carbide particles comprising silicon oxycarbide and silica on their surface,
densifying by infiltrating the preform with a composition based on molten silicon to give a part made of ceramic matrix composite material,
wherein the slurry further comprises at least one organic binder and the method comprises, before the infiltration of the preform with a composition based on molten silicon, a step of forming an amorphous carbon residue by pyrolysing the organic binder and a step of carbon reduction of the silicon oxycarbide and silica present on the surface of the silicon carbide particles by the carbon residue.

2. The method according to claim 1, wherein the slurry comprises between 1% and 20% by weight organic binder.

3. The method according to claim 1 wherein the organic binder is chosen from one of the following binders: polyvinyl alcohol (PVA), polyethylene glycol (PEG), glycerol, polymethylmethacrylate (PMMA), acrylic resin and polyvinyl butyral resin (PVB).

4. The method according to claim 1, wherein the fibrous preform comprises between 0.001% and 0.25% by weight amorphous carbon after the step of pyrolysis of the organic binder.

5. The method according to claim 1, wherein the pyrolysis step comprises an increase in temperature at a rate between 1° C./min and 3° C./min to a temperature plateau between 300° C. and 500° C., the temperature plateau being maintained for a duration of between 1 and 5 hours.

6. The method according to claim 1, further comprising, before the densifying, depositing on the fibres of the fibrous preform, an interphase of pyrolytic carbon, boron nitride or silicon-doped boron nitride.

7. A method comprising manufacturing a blade, a nozzle, a turbine ring or a combustion chamber of a gas turbine with the method of claim 1.
